(19) United States
(12) Patent Application Publication
(10) Pub. No.: US 2005/0067330 A1
(43) Pub. Date: Mar. 31, 2005

(54) Apparatus for sorting mail including mail receiving receptables arranged in an arcuate configuration

(76) Inventors: Murray Berlin, Sherwood Park (CA); Michael Byrne, Sherwood Park (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/498,384

(22) PCT Filed: Oct. 8, 2002
(86) PCT No.: PCT/CA02/01508

(30) Foreign Application Priority Data
Dec. 14, 2001 (CA) 2,365,061

(51) Int. Cl. B07C 5/00

(52) U.S. Cl. 209/584

(57) ABSTRACT

An apparatus for sorting mail includes at least one tier of mail receiving receptacles (12) arranged in an arcuate configuration. The preferred embodiment utilizes an arm (16) supported by a support (14) for pivotal movement about a substantially vertical pivot axis (22). The arm sweeps in an arc in close proximity with and conforming to the arcuate configuration of the tier of mail receiving receptacles (12). A conveyor (24) conveys individual pieces of mail (26) sequentially along the arm. A controller (36) is provided which is adapted to monitor the positioning of the arm (16) relative to the tier of mail receiving receptacles (12), selectively activate a drive motor (30) to alter the positioning of the arm (16), and selectively activate the conveyor (24) to convey individual pieces of mail (26) sequentially along the conveyor to the second end of the arm and into selected mail receiving receptacles. The apparatus provides a significant sorting capacity within a relatively compact space.

### FIELD OF THE INVENTION

The present invention relates to an apparatus for sorting mail

### BACKGROUND OF THE INVENTION

There are many organizations that receive large volumes of mail on a daily basis. Such organizations include utility companies, universities and cities. As the volume of mail increases for such organizations, a point is eventually reached at which at least some degree of mechanized sorting is a necessity. Mechanized mail sorting apparatus that are commercially available are large and require special facilities to accommodate them.

### SUMMARY OF THE INVENTION

What is required is a relatively compact apparatus for sorting mail that is suitable for use by organizations that receive large volumes of mail.

According to the present invention there is provided an apparatus for sorting mail which includes at least one tier of mail receiving receptacles arranged in an arcuate configuration. If additional capacity is required the arcuate configuration can extend around to form a substantially circular arcuate configuration. A conveyor is provided for conveying individual pieces of mail. A controller is provided which is adapted to selectively activate the conveyor to convey individual pieces of mail sequentially along the conveyor into selected mail receiving receptacles.

The mail sorting apparatus, as described above, provides a significant sorting capacity within a relatively compact space. Although a conventional conveyor system prevalent with other mail sorting apparatus can be used, it is preferred that a robotic arm be utilized. The arm has a first end and a second end. The first end of the arm is supported by an arm support. A drive motor imparts a rotational movement about a substantially vertical pivot axis to either the arm or the arm support, such that the arm sweeps in a horizontal arc in close proximity with and conforming to the arcuate configuration of the single tier of mail receiving receptacles. The conveyor conveys individual pieces of mail sequentially along the arm to the second end of the arm. Means is provided for determining the horizontal positioning of the arm. The controller monitors the horizontal positioning of the arm relative to the mail receiving receptacles, selectively activates the drive motor to alter the horizontal positioning of the arm, and selectively activates the conveyor to convey individual pieces of mail sequentially along the conveyor to the second end of the arm and into selected mail receiving receptacles.

Although beneficial results may be obtained through the use of the mail sorting apparatus, as described above, over time the volume of mail received by an organization tends to increase. It is, therefore, desirable that the capacity of the mail sorting apparatus be capable of being expanded as the volumes of mail increase. Even more beneficial results may be obtained when there are several tiers positioned one above the other, and means is provided to raise and lower the arm to vertically align the arm with a selected one of the several tiers. This allows greater sorting capacity within essentially the same space constraints. It also allows the capacity of the mail sorting apparatus to be expanded by adding additional tiers.

With smaller volumes of mail a batch system can be used having a mail cassette filled with individual pieces of mail that is inserted into a first end of the arm. However, even more beneficial results may be obtained when mail is continuously fed onto the conveyor of the arm from a feeding station that provides mail receptacle destination input.

It is difficult to continuously feed individual pieces of mail into an arm that is continuously being raised and lowered to vertically align with several tiers. Even more beneficial results may, therefore, be obtained when mail is fed down the support onto the conveyor of the arm.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a first embodiment of mail sorting apparatus constructed in accordance with the teachings of the present invention.

FIG. 2 is a side elevation view, in section, of the mail sorting apparatus illustrated in FIG. 1.

FIG. 3 is a perspective view of a second embodiment of mail sorting apparatus constructed in accordance with the teachings of the present invention.

FIG. 4 is a side elevation view, in section, of the mail sorting apparatus illustrated in FIG. 3.

FIG. 5 is a perspective view of first drive assembly for the mail sorting apparatus illustrated in FIG. 3.

FIG. 6 is a perspective view of second drive assembly for the mail sorting apparatus illustrated in FIGS. 1 and 3.

### DETAILED DESCRIPTION OF THE PREFERRED EMBODIMENT

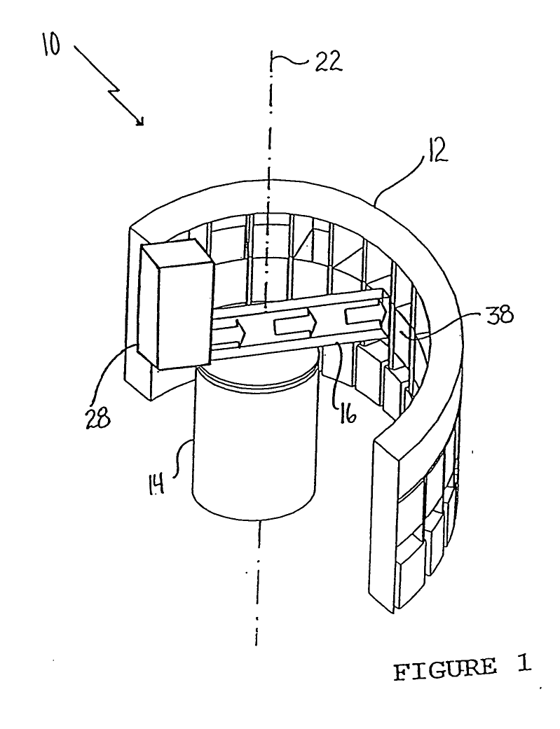

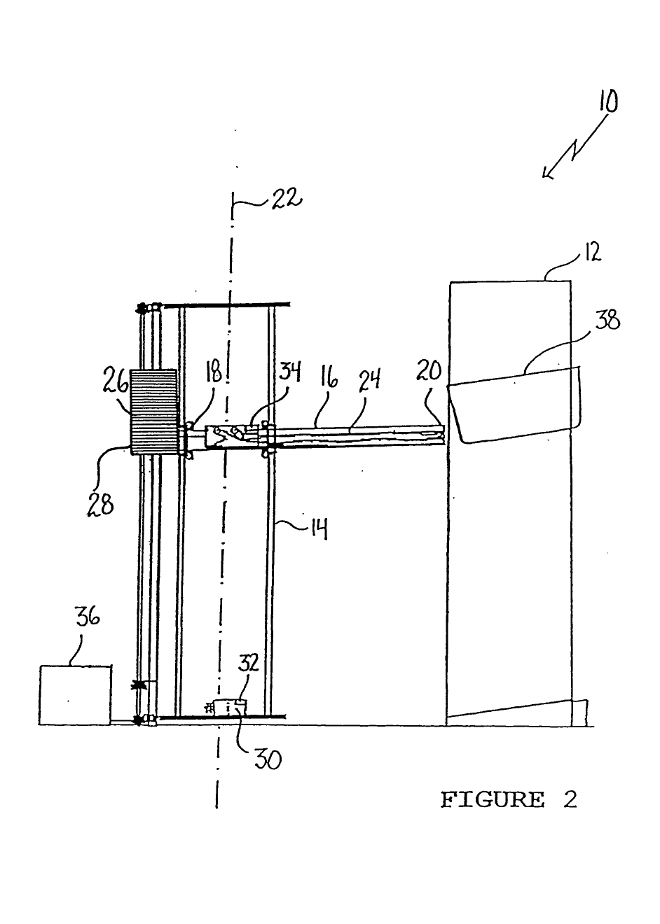

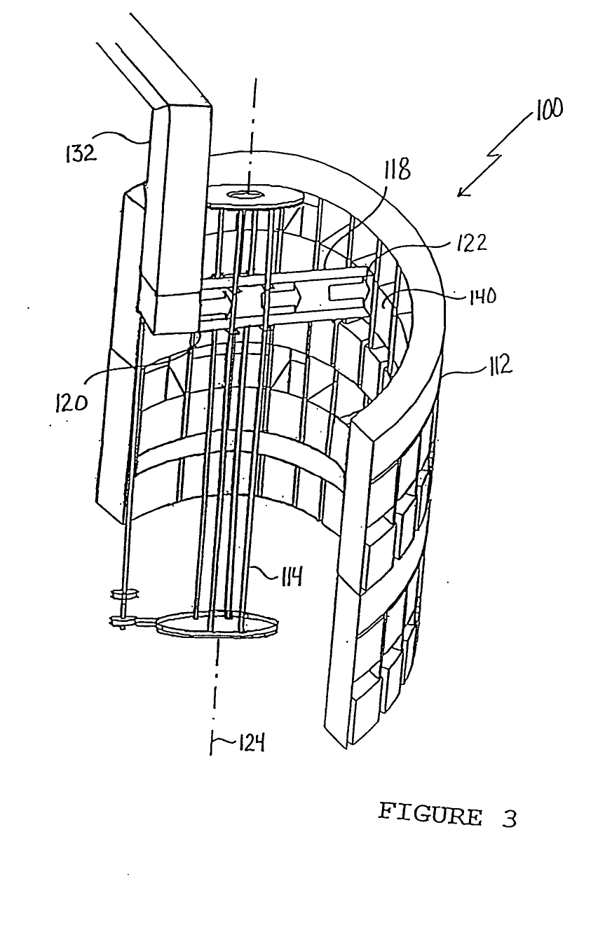

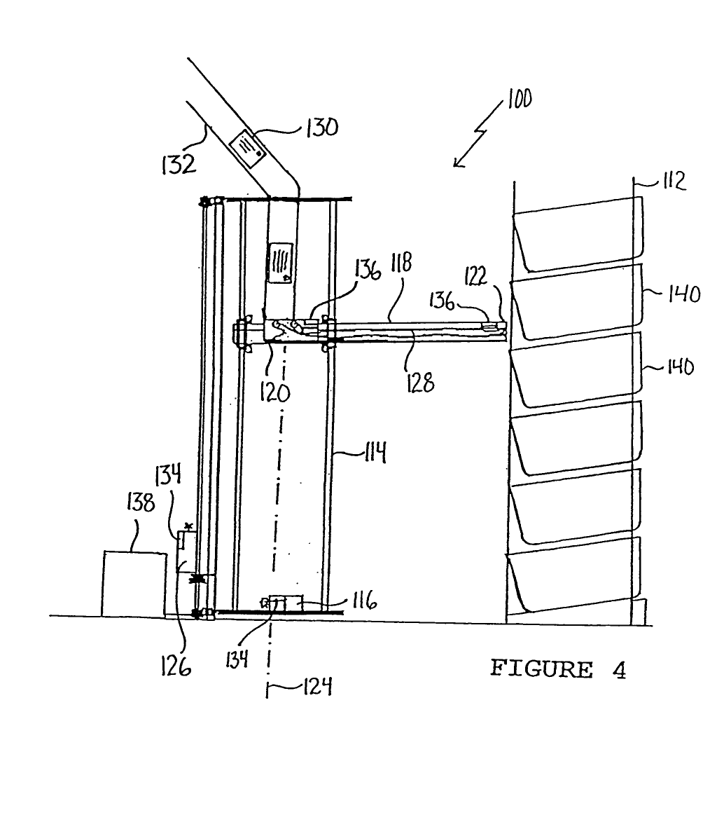

The two preferred embodiments of an apparatus for sorting mail will now be described. A first embodiment of mail sorting apparatus having a single tier and generally identified by reference numeral 10, will be described with reference to FIGS. 1 and 2. A second embodiment of mail sorting apparatus having several tiers and generally identified by reference numeral 100, will be described with reference to FIGS. 3 through 4.

Structure and Relationship of Parts of Mail Sorting Apparatus 10:

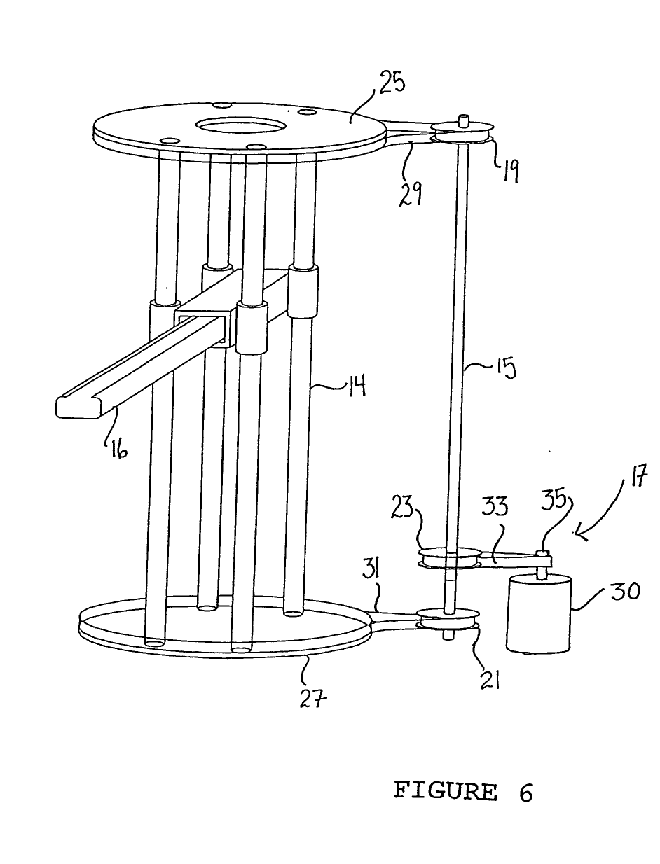

Referring to FIG. 1, there is provided a mail sorting apparatus 10 which includes a single tier of mail receiving receptacles 12 arranged in an arcuate configuration, an arm support 14 and an arm 16. Arm 16 has a first end 18 and a second end 20. First end 18 of arm 16 is supported by support 14 for pivotal movement about a substantially vertical pivot axis 22, such that arm 16 sweeps in an arc in close proximity with and conforming to the arcuate configuration of single tier of mail receiving receptacles 12. Referring to FIG. 2, a conveyor 24 is provided to convey individual pieces of mail 26 sequentially along arm 16 to second end 20 of arm 16. A mail cassette 28 that is filled with individual pieces of mail 26 is inserted into first end 18 of arm 16 to feed mail 26 onto conveyor 24. A drive motor 30 is provided for altering the positioning of arm 16. There are two ways which drive motor 30 can be configured. Drive motor 30 can be configured to impart a rotational movement about pivot axis 22 to arm 16 relative to support 14 or arm 16 can be fixed to support 14 and drive motor 30 can be configured to move arm 16 by rotating support 14. In the illustrated embodiment, drive motor 30 alters the horizontal positioning of arm 16 by rotating support 14. This configuration is preferred due to the fact it more readily enables additional tiers to be added, as will hereinafter be further described in relation to the second embodiment, mail sorting apparatus 100. Drive motor 30 imparts rotational movement to shaft 15 which forms part of a drive assembly, generally indicated by reference numeral 17 in FIG. 6. Shaft 15 extends vertically parallel to support column 14. Shaft 15 supports three pulleys an upper pulley 19, a lower pulley 21, and an intermediate pulley 23. Support column 14 also has an upper pulley 25 and a lower pulley 27. An upper drive belt 29 extends between upper pulley 19 of shaft 15 and upper pulley 25 of support column 14. A lower drive belt 31 extends between lower pulley 21 of shaft 15 and lower pulley 27 of support column 14. When shaft 15 rotates the rotational force is transmitted via upper drive belt 29 and lower drive belt 31 from shaft 15 to support column 14. Intermediate pulley 23 receives a drive belt 33 which connects to an output shaft 35 of drive motor 30. It is preferred that drive motor 30 is a servo type drive motor, however it will be appreciated that other types of drive motors could also be used. Encoders 32 are incorporated into drive motor 30 to sense the positioning of arm 16.

Mail sensors 34 are positioned on arm 16 to sense the position of mail 26 on conveyor 24. In the illustrated embodiment, mail sensors 34 are positioned at first end 18 of arm 16, however it will be appreciated that mail sensors 34 could be placed at various positions along arm 16 depending on the configuration of apparatus 10.

A controller 36 is provided that is preprogrammed with the positioning of each mail receiving receptacle 38 of single tier of mail receiving receptacles 12. Controller 36 receives data from encoders 32 to monitor the positioning of arm 16 relative to single tier of mail receiving receptacles 12 and then selectively activates drive motor 30 to alter the pivotal positioning of arm 16. Controller 36 also receives data from mail sensors 34 and selectively activates conveyor 24 to convey individual pieces of mail 26 sequentially along conveyor 24 to second end 20 of arm 16 and into selected mail receiving receptacles 38.

Operation of Mail Sorting Apparatus 10:

The use and operation of mail sorting apparatus 10 will now be described with reference to FIGS. 1 and 2. Referring to FIG. 1, mail sorting apparatus 10 is provided as described above, when smaller volumes of mail 26 are required to be sorted. Mail 26 that is intended to be sorted is loaded into mail cassette 28. Mail cassette 28 is then fitted onto first end 18 of arm 16. Referring to FIG. 2, mail 26 from mail cassette 28 is continuously fed onto conveyor 24 of arm 16. Controller 36 receives data from encoders 32 to monitor the positioning of arm 16 relative to several tiers of mail receiving receptacles 12. Controller 36 then selectively activates drive motor 30 alter the pivotal positioning of arm 16, as well as selectively activating conveyor 24 to convey individual pieces of mail 26 sequentially along conveyor 24 to second end 20 of arm 16 and into selected mail receiving receptacles 38.

Structure and Relationship of Parts of Mail Sorting Apparatus 100:

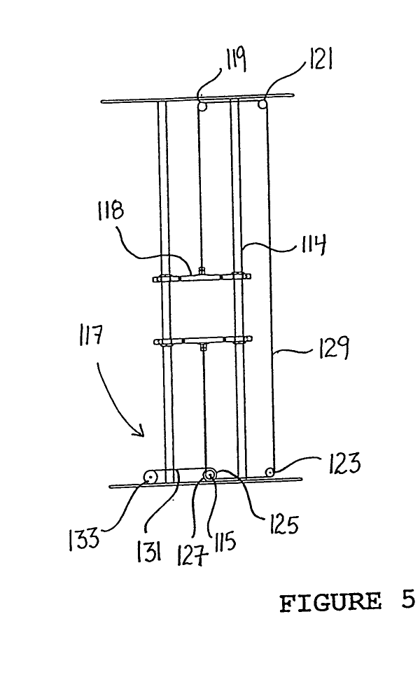

Referring to FIG. 3, there is provided an alternative embodiment of apparatus for sorting mail generally referenced by numeral 100. Alternative embodiment 100 includes several tiers 112 of mail receiving receptacles 140 positioned one above the other. Each of several tiers 112 of mail receiving receptacles 140 are arranged in an arcuate configuration. Referring to FIG. 4, a vertical support column 114 is mounted for rotational movement about a substantially vertical pivot axis 124. An arm 118 is provided which has a first end 120 and a second end 122. First end 122 of arm 118 is supported by support column 114. Arm 118 is vertically movable up and down support column 114. A first drive motor 116 is provided for imparting movement of arm 118 vertically up and down support column 114. First drive motor 116 imparts rotational movement to a shaft 115 which forms part of a first drive assembly, generally indicated by reference numeral 117 in FIG. 5. Shaft 115 extends horizontally relative to support column 114. Pulleys are supported by support column 114, two upper pulleys 119 and 121, two lower pulleys 123 and 125, and a power input pulley 127. An endless drive belt 129 is formed in a loop which engages upper pulleys 119 and 121 as well as lower pulleys 123 and 125. The drive belt loop 129 is closed by attachment to arm 118. Lower pulley 125 and power input pulley 127 are both positioned on shaft 115. When shaft 115 rotates in a clockwise direction, drive belt loop 129 rotates clockwise to draw arm 118 up support column 114. When shaft 115 rotates in a counterclockwise direction, drive belt loop 129 rotates counterclockwise to draw arm 118 down support column 114. Power input pulley 127 engages a drive belt 131 which connects to an output shaft 133 of first drive motor 116. First drive motor 116 provides a motivating force to first drive assembly 117 via output shaft 133, drive belt 131, and power input pulley 127. A second drive motor 126 is provided for rotating support column 114 to alter the horizontal positioning of arm 118. Second drive motor 126 provides a motivating force to a second drive assembly, which is identical to drive assembly to drive assembly 17 illustrated in FIG. 6 and described above and will, therefore, not be further described. As support column 114 rotates arm 118 sweeps in a horizontal arc in close proximity with and conforming to the arcuate configuration of a selected one of tiers 112 of mail receiving receptacles 140.

A conveyor 128 conveys individual pieces of mail 130 sequentially along arm 118 to second end 122 of arm 118. Mail 130 is continuously fed from a feeding station 132 to conveyor 128 of arm 118. In the illustrated embodiment, feeding station 132 is shown as inputting mail from above, however, feeding station 132 could input mail from behind, below or the side as well. Encoders 134 are incorporated into first drive motor 116 and second drive motor 126 to sense the positioning of arm 118. Mail sensors 136 are positioned at first end 120 and second end 122 of arm 118 to sense the position on conveyor 128 of individual pieces of mail 130. It will be appreciated that mail sensors 136 could be placed in differing positions on arm 118 depending on the configuration of apparatus 100. In the illustrated embodiment, mail sensors 136 are positioned at first end 120 of arm and at second end 122 of arm 118. A controller 138 is provided which has been preprogrammed with the X coordinate and the Y coordinate of each mail receiving receptacle 140 of several tiers 112 of mail receiving receptacles 140. Controller 138 receives data from encoders 134 to monitor the positioning of arm 118 relative to several tiers 112 of mail receiving receptacles 140.

Operation of Mail Sorting Apparatus 100:

The use and operation of second embodiment of mail sorting apparatus 100 will now be described with reference to FIGS. 3 and 4. Referring to FIG. 3, second embodiment of mail sorting apparatus 100 is provided as described above, when greater volumes of mail 130 are required to be sorted. Referring to FIG. 4, mail 130 that is intended to be sorted is continuously fed from feeding station 132 onto conveyor 128 of arm 118. Mail sensors 136 that are positioned at first end 120 and second end 122 of arm 118 sense the position on conveyor 128 of individual pieces of mail 130. Controller 138 receives data from encoders 134 to monitor the positioning of arm 118 relative to several tiers of mail receiving receptacles 112. Controller 138 then selectively activates first drive motor 116 to move arm 118 vertically along support column 114 to vertically align arm 118 with a selected tier 112 of the several tiers of mail receiving receptacles 112. Controller 138 concurrently selectively activates second drive 126 to alter the pivotal positioning of arm 118, as well as selectively activating conveyor 128 to convey individual pieces of mail 130 sequentially along conveyor 128 to second end 122 of arm 118 and into selected mail receiving receptacles 140 having correct X coordinates and Y coordinates.

In order to the above described apparatus to operate, the controllers must be able to determine which mail receptacle an individual piece of mail is to be directed to. For this reason, these apparatus must work in conjunction with one of the technologies currently available for reading mail. There are various technologies which are capable of providing information into the controllers regarding the destination of each individual piece of mail. Commercial voice recognition software can be used to read in the information to the controller. Alternatively, optical character recognition (OCR) software, or bar code scanners could be used. The key aspect of the invention is that once the controller knows the addressee of an individual piece of mail, it is capable of rapidly delivering it to the correct mail receptacle.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. An apparatus for sorting mail having several tiers of horizontally aligned mail receiving receptacles arranged in an arcuate configuration, means for conveying individual pieces of mail and a controller adapted to selectively activate the conveyance means to convey individual pieces of mail sequentially into selected mail receiving receptacles, characterized by:
the tiers of mail receiving receptacles being horizontally aligned;
the means for conveying individual pieces of mail including an arm support;
is an arm having a first end and a second end, the first end of the arm being supported by the support;
a first drive means for raising and lowering the arm relative to the arm support to vertically align the arm with a selected one of the several tiers, while always maintaining the arm in a substantially horizontal orientation;
a second drive means for imparting a rotational movement about a substantially vertical pivot axis to the arm support, such that as the arm support rotates the arm sweeps in a horizontal arc in close proximity with and conforming to the arcuate configuration of the mail receiving receptacles;
conveyance means to convey individual pieces of mail sequentially along the arm to the second end of the arm;
means for determining the horizontal and vertical positioning of the arm; and
the controller being adapted to monitor the horizontal and vertical positioning of the arm relative to the mail receiving receptacles, selectively activate the first drive means to alter the vertical positioning of the arm relative to the arm support, selectively activate the second drive means to rotate the arm support to alter the horizontal positioning of the arm, and selectively activate the conveyance means to convey individual pieces of mail sequentially to the second end of the arm and into selected mail receiving receptacles, the controller being pre-programmed with the X coordinate and the Y coordinate of each mail receiving receptacle of the several tiers of mail receiving receptacles.

2. The apparatus for sorting mail as defined in claim 1, wherein the arm has a mail cassette that holds several pieces of mail which is intermittently filled, mail being fed onto the conveyance means of the arm from the mail cassette.

3. The apparatus for sorting mail as defined in claim 1, wherein mail is continuously fed onto the conveyance means of the arm from a feeding station.

4. The apparatus for sorting mail as defined in claim 3, wherein the feeding station provides mail receptacle destination input to the controller.

5. The apparatus for sorting mail as defined in claim 1, wherein mail is fed from above down the arm support onto the conveyor of the arm.

6. The apparatus for sorting mail as defined in claim 1, wherein encoders are positioned to sense the vertical and horizontal positioning of the arm.

7. The apparatus for sorting mail as defined in claim 1, wherein mail sensors are positioned on the conveyor to sense the position on the conveyance means of individual pieces of mail and communicate that information to the controller.

8. The apparatus for sorting mail as defined in claim 1, wherein the first drive means imparts movement of the arm through a first drive assembly, comprising:
a shaft extending horizontally relative to the support; at least one pulley mounted on the shaft for rotation with the shaft;
several pulleys mounted on the support;
an endless drive loop extending between the at least one pulley on the shaft and the pulleys on the support, such that rotation of the shaft in a clockwise direction moves the arm up the support and rotation of the shaft in a counterclockwise direction moves the arm down the support; and
means for coupling the first drive means to the first drive assembly to selectively drive the shaft in a clockwise and counterclockwise direction.

9. The apparatus for sorting mail as defined in claim 1, wherein the second drive motor imparts rotational movement to the support through a second drive assembly, comprising:
a shaft extending vertically parallel to the support;
at least one pulley mounted on the shaft for rotation with the shaft;
at least one pulley mounted on the support;
an endless drive loop extending between the at least one pulley on the shaft and the at least one pulley on the support, such that rotation of the shaft serves to rotate the support; and
means for coupling the second drive motor to the second drive assembly to selectively drive the shaft in a clockwise and counterclockwise direction.
